(19) United States
(12) Patent Application Publication
(10) Pub. No.: US 2012/0130646 A1
(43) Pub. Date: May 24, 2012

(54) ANALYTE TESTING METHOD AND SYSTEM WITH HIGH AND LOW ANALYTE TRENDS NOTIFICATION

(75) Inventors: Jeremy LANDIS, New York City, NY (US); Salve Retuta Pascual, Washington, DC (US); Anita Mathew, Los Altos, CA (US)

(73) Assignee: LifeScan, Inc., Milpitas, CA (US)

(21) Appl. No.: 13/192,348

(22) Filed: Jul. 27, 2011

Related U.S. Application Data
(60) Provisional application No. 61/415,598, filed on Nov. 19, 2010.
(60) Provisional application No. 61/469,046, filed on Mar. 29, 2011.

(51) Int. Cl. G06F 19/00

(52) U.S. Cl. 702/19

(57) ABSTRACT

Described herein are systems and methods to utilize factual information based on stored analyte data to allow greater insight into a chronic disease of a user, such as, for example a diabetic patient.

This application claims the benefits under 35 USC §119 or 120 of prior provisional application Ser. Nos. 61/415,598 (Attorney Docket No. LFS5217USPSP) filed on Nov. 19, 2010 and 61/469,046 (Attorney Docket No. LFS2222USPSP) filed on Mar. 29, 2011, which is hereby incorporated by reference into this application in its entirety.

### BACKGROUND

Glucose monitoring is a fact of everyday life for diabetic individuals. The accuracy of such monitoring can significantly affect the health and ultimately the quality of life of the person with diabetes. Generally, a diabetic patient measures blood glucose levels several times a day to monitor and control blood sugar levels. Failure to test blood glucose levels accurately and on a regular basis can result in serious diabetes-related complications, including cardiovascular disease, kidney disease, nerve damage and blindness. There are a number of electronic devices currently available which enable an individual to test the glucose level in a small sample of blood. One such glucose meter is the OneTouch® Profile™ glucose meter, a product which is manufactured by LifeScan.

In addition to glucose monitoring, diabetic individuals often have to maintain tight control over their lifestyle, so that they are not adversely affected by, for example, irregular food consumption or exercise. In addition, a physician dealing with a particular diabetic individual may require detailed information on the lifestyle of the individual to provide effective treatment or modification of treatment for controlling diabetes. Currently, one of the ways of monitoring the lifestyle of an individual with diabetes has been for the individual to keep a paper logbook of their lifestyle. Another way is for an individual to simply rely on remembering facts about their lifestyle and then relay these details to their physician on each visit.

The aforementioned methods of recording lifestyle information are inherently difficult, time consuming, and possibly inaccurate. Paper logbooks are not necessarily always carried by an individual and may not be accurately completed when required. Such paper logbooks are small and it is therefore difficult to enter detailed information requiring detailed descriptors of lifestyle events. Furthermore, an individual may often forget key facts about their lifestyle when questioned by a physician who has to manually review and interpret information from a hand-written notebook. There is no analysis provided by the paper logbook to distill or separate the component information. Also, there are no graphical reductions or summary of the information. Entry of data into a secondary data storage system, such as a database or other electronic system, requires a laborious transcription of information, including lifestyle data, into this secondary data storage. Difficulty of data recordation encourages retrospective entry of pertinent information that results in inaccurate and incomplete records.

There currently exist a number of portable electronic devices that can measure analyte levels in an individual and store the levels for recalling or uploading to another computer for analysis. However, the known system only permits a limited selection of lifestyle variables to be stored in a meter. There is a no intelligent feedback from values previously entered into the meter and the user interface is unintuitive for an infrequent user of the meter. Another device is the Agamatrix WaveSense. However, the WaveSense does not provide for detection of high trend or low trend.

### SUMMARY OF THE DISCLOSURE

In an embodiment, a method of notifying a user of high or low trends in analyte values obtained with an analyte measurement unit and used in conjunction with a mobile communication device. Each of the analyte measurement unit and the communication device includes a microprocessor coupled to respective displays and memory storage devices. The method can be achieved by: transforming with the analyte measurement unit, an analyte in a physiological fluid into an enzymatic by-product and in the process provide a measurement of the analyte in the fluid; storing in the memory of the analyte measurement unit, one or more of the analyte measurements; determining with the mobile communication device, whether a most recent analyte measurement at a given time during a day is below a first threshold; evaluating with the mobile communication device, whether at least one analyte measurement of the plurality of analyte measurements performed within a time frame of X hours about the given time of the most recent analyte measurement over a period of N days, is lower than a first threshold; and annunciating in the mobile communication unit that, in the same time frame over the N number of days, the plurality of analyte measurements indicates a analyte trend lower than the first threshold.

In yet another embodiment, a method of notifying a user of high or low trends in analyte values obtained with an analyte measurement unit and used in conjunction with a mobile communication device. Each of the analyte measurement unit and the communication device includes a microprocessor coupled to respective displays and memory storage devices. The method can be achieved by: initiating with the analyte measurement unit, a transformation of an analyte in a physiological fluid into an enzymatic by-product and in the process provide a measurement of the analyte in the fluid; storing in the memory of the analyte measurement unit, one or more of the analyte measurements; determining whether a most recent analyte measurement at a given time during a day is above a second threshold; confirming whether the most recent analyte measure was flagged as either one or both of (a) a measurement made before a meal or (b) a measurement made during a fasting period; evaluating with the mobile communication device, whether at least one analyte measurement of the plurality of analyte measurements performed within a time frame of X hours about the given time of the most recent analyte measurement over a period of N days, is higher than the second threshold; and annunciating that in the same time frame over the N number of days, the plurality of analyte measurements indicates a analyte trend higher than a second threshold.

In yet a further embodiment, a method of notifying a user of high or low trends in analyte values obtained with an analyte measurement unit and used in conjunction with a mobile communication device. Each of the analyte measurement unit and the communication device includes a microprocessor coupled to respective displays and memory storage devices. The method can be achieved by: initiating with the analyte measurement unit, a transformation of an analyte in a physiological fluid into an enzymatic by-product and in the process provide a measurement of the analyte in the fluid; storing in the memory of the analyte measurement unit, one or more of the analyte measurements; determining whether a most recent analyte measurement at a given time during a day is above a second threshold; confirming whether the most recent analyte measure was flagged as either one or both of as (a) a measurement made before a meal or (b) a measurement made during a fasting period; evaluating with the mobile communication device, whether at least one analyte measurement of the plurality of analyte measurements performed within a time frame of X hours about the given time of the most recent analyte measurement over a period of N days, is higher than the second threshold; and annunciating that in the same time frame over the N number of days, the plurality of analyte measurements indicates a analyte trend higher than a second threshold; and displaying a plurality of analyte measurements on the display of the mobile communication device in a table having multiple rows and multiple columns with respective row header and column header, the column header signifying different time periods during a day with subdivisions of each of the column header to signify a before meal or after meal analyte measurement within each time period of the day, and the row header signifying the date of each analyte measurement, and in which numerical values representing analyte values identified as part of one analyte trend are represented by a first indicia and as part of another analyte trend by a second indicia different from the first indicia.

In another embodiment, a chronic disease management system is provided that includes an analyte measurement unit and mobile communication unit. The analyte measurement unit includes a housing and a test strip port configured to receive an analyte test strip with a test strip port to provide data regarding an amount of an analyte from a user's physiological fluid deposited on one or more test strips, and an analyte microprocessor coupled to a memory. The memory is configured to store data representing a plurality of analyte measurements. The mobile communication unit includes a mobile processor coupled to a display. One of the analyte microprocessor or the mobile microprocessor is configured to determine whether at least one analyte measurement of the plurality of analyte measurements performed within a time frame of X hours about the given time of a most recent analyte measurement over a period of N days, is lower than a first threshold, and display in a time frame over the N number of days, an analyte trend lower than the first threshold with a first indicia.

In yet another aspect, a chronic disease management system is provided that includes an analyte measurement unit and mobile communication unit. The analyte measurement unit includes a housing and a test strip port configured to receive an analyte test strip with a test strip port to provide data regarding an amount of an analyte from a user's physiological fluid deposited on one or more test strips, and an analyte microprocessor coupled to a memory. The memory is configured to store data representing a plurality of analyte measurements. The mobile communication unit includes a mobile processor coupled to a display. One of the analyte microprocessor or the mobile microprocessor is configured to determine whether at least one analyte measurement of the plurality of analyte measurements performed within a time frame of X hours about the given time of a most recent analyte measurement over a period of N days, is higher than the second threshold, and display in a time frame over the N number of days, an analyte trend higher than the second threshold.

These and other embodiments, features and advantages will become apparent to those skilled in the art when taken with reference to the following more detailed description of various exemplary embodiments of the invention in conjunction with the accompanying drawings that are first briefly described.

### BRIEF DESCRIPTION OF THE FIGURES

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates a chronic disease management system that includes an analyte measurement unit and a mobile communication device.

FIG. 1B illustrates, in simplified schematic, an exemplary circuit board for each of the analyte measurement unit and the mobile communication device.

FIGS. 2A and 2B illustrate two variations on a logic for determining a low trend;

FIGS. 3A and 3B illustrate two variations on a logic for determining a high trend;

FIG. 4A illustrates a pop-up message to indicate a low trend while the touch screen is in the summary screen.

FIG. 4B illustrates a detailed text screen that a user may select in response to the selection provided in the pop-up of FIG. 4A.

FIG. 5A illustrates a unique output for the logbook display of the mobile communication device.

FIG. 5B illustrates a screen generated that provides additional details for the low trend identified on July 25 to July 26 for the “Morning” time interval.

FIG. 5C illustrates an alternate screen of the logbook display.

FIG. 6A illustrates a screen that allows the user to select between obtaining help for the interpretation of the trending patterns or sharing the log-book with others.

FIG. 6B illustrates a follow-up screen to allow the user to share via email or text messaging of the log-book in FIG. 6A.

FIGS. 7A and 7B represent an alternate mode of annunciating measurement values over time to the user using a graphical approach.

FIG. 8 represents yet another mode of annunciating measurement values over a number of days during the same time window using a graphical approach.

### MODES OF CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. In addition, as used herein, the terms “patient,” “host,” “user,” and “subject” refer to any human or animal subject and are not intended to limit the systems or methods to human use, although use of the subject invention in a human patient represents a preferred embodiment. Also, the term “analyte” indicates any component (e.g., glucose, ketone, urea, cholesterol, hematocrit and so on) of any fluid extractable from a user (hereafter “physiological fluid”) including but not limited to blood, urine, saliva, or sweat.

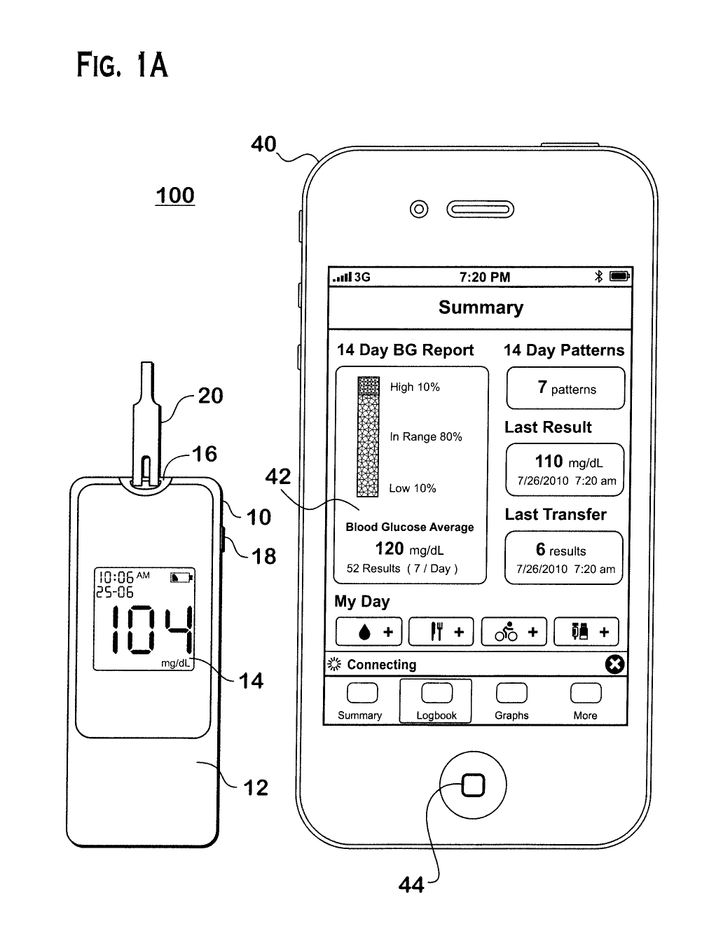

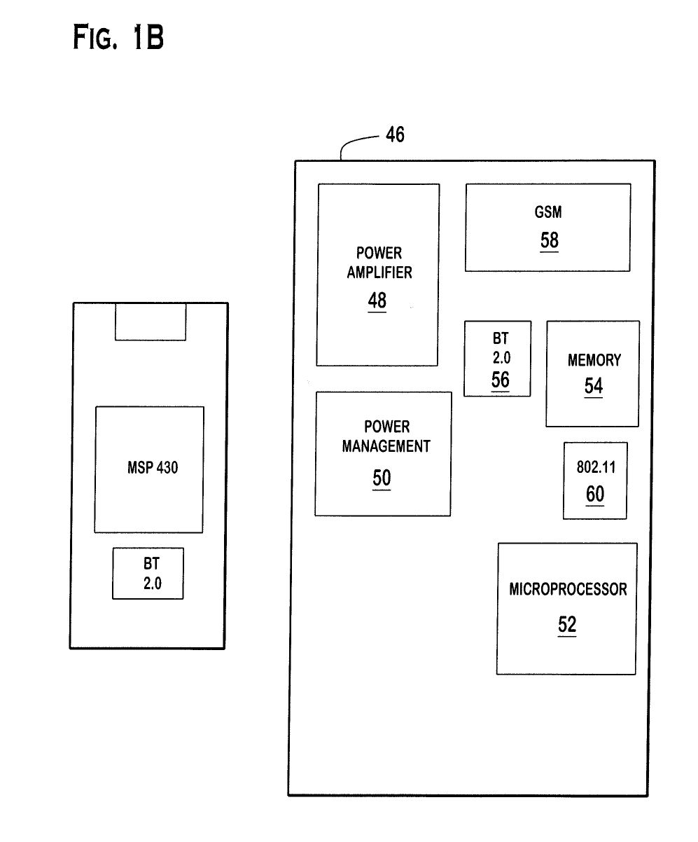

FIG. 1A illustrates A chronic disease management system 100 that includes an analyte measurement unit 10 (“AMU”) with a biosensor in the form of a glucose test strip 20 and a mobile communication device 40. Glucose meter or AMU 10 can include a housing 12, a display 14, a strip port connector 16, and a data port 18, as illustrated in FIG. 1A. Although no button is shown, a touch screen with virtual buttons may be utilized. The communication device 40 includes a display 42 preferably a touch screen type display with a mechanical home switch 44.

FIG. 1B illustrates (in simplified schematic form) the electronic components of the AMU 10 disposed on a top surface of circuit board 22. On the top surface, the electronic components include a strip port connector 16, a microcontroller 24, a display connector 14a, a non-volatile memory 40, a clock 42, and a first wireless module 26. On the bottom surface, the electronic components may include a battery connector (not shown) and a data port 18. Microcontroller 24 can be electrically connected to strip port connector 16, operational amplifier circuit (not shown for brevity), wireless module 26, display 14, non-volatile memory (not shown for brevity) clock (not shown for brevity), battery (not shown for brevity), and data port 18.

Operational amplifier circuit (not shown for brevity) can include two or more operational amplifiers configured to provide a portion of the potentiostat function and the current measurement function. The potentiostat function can refer to the application of a test voltage between at least two electrodes of a test strip. The current function can refer to the measurement of a test current resulting from the applied test voltage. The current measurement may be performed with a current-to-voltage converter. Microcontroller 24 can be in the form of a mixed signal microprocessor (MSP) such as, for example, the Texas Instrument MSP 430. The MSP 430 can be configured to also perform a portion of the potentiostat function and the current measurement function. In addition, the MSP 430 can also include volatile and non-volatile memory. In another embodiment, many of the electronic components can be integrated with the microcontroller in the form of an application specific integrated circuit (ASIC).

Strip port connector 16 can be configured to form an electrical connection to the test strip. Display 14 can be in the form of a liquid crystal display for reporting measured analyte levels, and for facilitating entry of lifestyle related information. Display 14 can optionally include a backlight. Alternatively, display 14 may include a touch-screen display to allow for entry of data and responses without requiring buttons and switches. Data port 18 can accept a suitable connector attached to a connecting lead, thereby allowing AMU 10 to be linked to an external device such as a personal computer or allow rechargeable battery of the meter 10 to be recharged. Data port 18 can be any port that allows for transmission of data such as, for example, a serial, USB, or a parallel port. Preferably, data port 18 is in the form of a USB 2.0 port. Clock (not shown for brevity) can be configured to keep current time related to the geographic region in which the user is located and also for measuring time. The AMU 10 can be configured to be electrically connected to a power supply such as, for example, a battery.

The AMU 10 is designed to work with a suitable analyte test strip (e.g., electrochemical or photochemical) that provides for one or more measurements of analytes in physiological fluid such as, for example, glucose, ketone, cholesterol and the like. In one exemplary embodiment, test strip 20 can be in the form of an electrochemical glucose test strip. Test strip 20 can include one or more working electrodes and a counter electrode. Test strip 20 can also include a plurality of electrical contact pads, where each electrode can be in electrical communication with at least one electrical contact pad. Strip port connector 16 can be configured to electrically interface to the electrical contact pads and form electrical communication with the electrodes. Test strip 20 can include a reagent layer that is disposed over at least one electrode. The reagent layer can include an enzyme and a mediator. Exemplary enzymes suitable for use in the reagent layer include glucose oxidase, glucose dehydrogenase (with pyrroloquinoline quinone co-factor, “PQQ”), and glucose dehydrogenase (with flavin adenine dinucleotide co-factor, “FAD”). An exemplary mediator suitable for use in the reagent layer includes ferricyanide, which in this case is in the oxidized form. The reagent layer can be configured to physically transform an analyte (e.g. glucose) into an enzymatic by-product and in the process generate an amount of reduced mediator (e.g., ferrocyanide) that is proportional to the analyte concentration. The working electrode can then measure a concentration of the reduced mediator in the form of a current. In turn, AMU 10 can convert the current magnitude into an analyte concentration. Details of the preferred test strip are provided in U.S. Pat. Nos. 6,179,979; 7,045,046; 7,291,256; 7,498,132, all of which are incorporated by reference in their entireties herein.

Referring again to FIG. 1B, a circuit board 46 of the hand-held computing unit 40 is shown with certain components disposed thereon in schematic form. A power amplifier chipset 48 along with a power management chipset 50 is provided for a microprocessor 52, which is coupled to a memory chipset 54, wireless communication module 56 (e.g. Bluetooth 2.0), GSM or GPRS chipset 58, and Wi-Fi chipset 60. Examples of commercially available portable communication device include the Blackberry Torch Smartphone, Android Smartphone, iPhone, iPod Touch, iPad, and others from Nokia, LG, Samsung, and Motorola. It should be noted that the portable communication device for use herein does not have to be smartphone but may include any hand-held portable computing device with the ability to communicate data to a server and back there from. Preferably, the portable communication device is the iPhone 4G.

In operation, a patient may begin the use of system 100 by performing a blood test. Specifically, a suitable test strip 20 is inserted into the AMU 10 to turn on the device. Blood or a suitable physiological fluid is extracted by a suitable device (e.g., a lancet) and deposited on a distal end of the strip 20. Deposition of fluid initiates a physical transformation of the analyte (e.g., glucose) into an enzymatic by-product such as, for example, gluconic acid, thereby allowing the AMU 10 to measure current flow from the enzymatic reaction in a test chamber of the test strip. After the enzymatic reaction has taken place and the current from the reaction measured, analyte result or in the exemplary embodiment, a blood glucose (“BG”) result at 202 is annunciated to the user. As used here, the term “annunciated” and variations on the root term indicate that an announcement may be provided via text, audio, visual or a combination of all modes of communication to a user.

The result from the test (e.g., electrochemical or electro-optical) is also transferred, if possible, immediately to the hand-held computing unit 40 for further processing in order to assist the user in management of the user's health or disease. Various functionalities are provided in the system 100, which are shown and described in Provisional U.S. Patent Application Ser. No. 61/308,217 filed 25 Feb. 2010 (Attorney Docket No. DDI-5194USPSP) and U.S. patent application Ser. No. 12/826,543 (Attorney Docket No. DDI-5194USNP) filed 9 Jun. 2010, which are incorporated by reference in its entirety into this application. It should be noted that the functionalities described by the previously mentioned application can be utilized in either the AMU 10 or the HCU 40, in part or in whole in either or both of the devices.

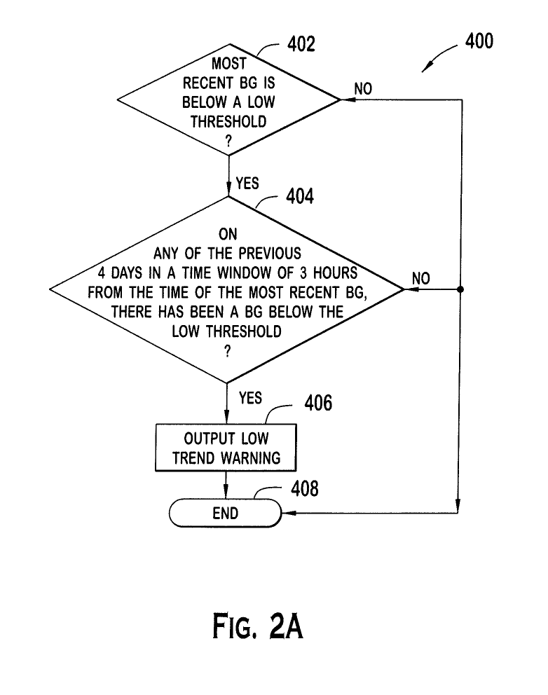

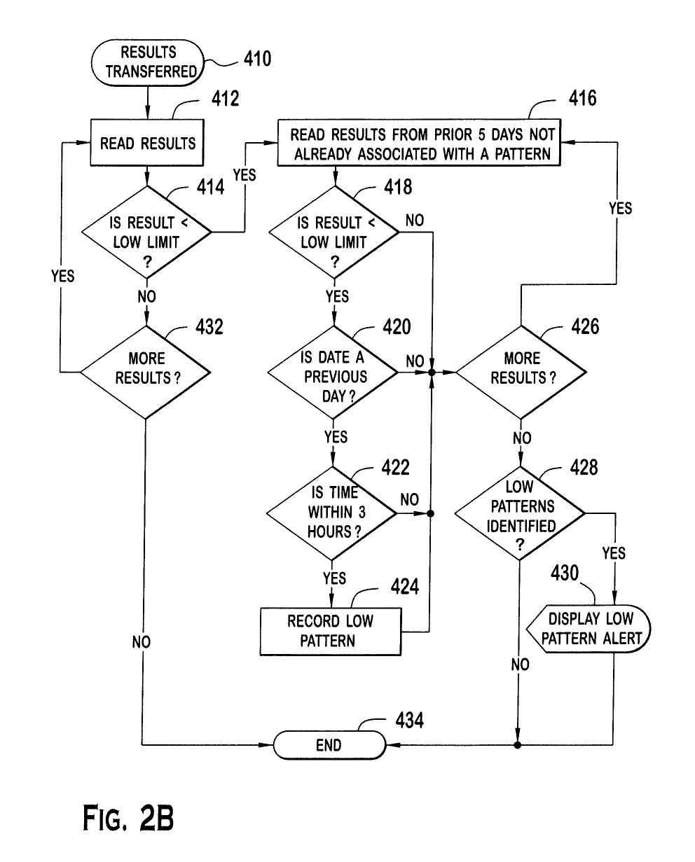

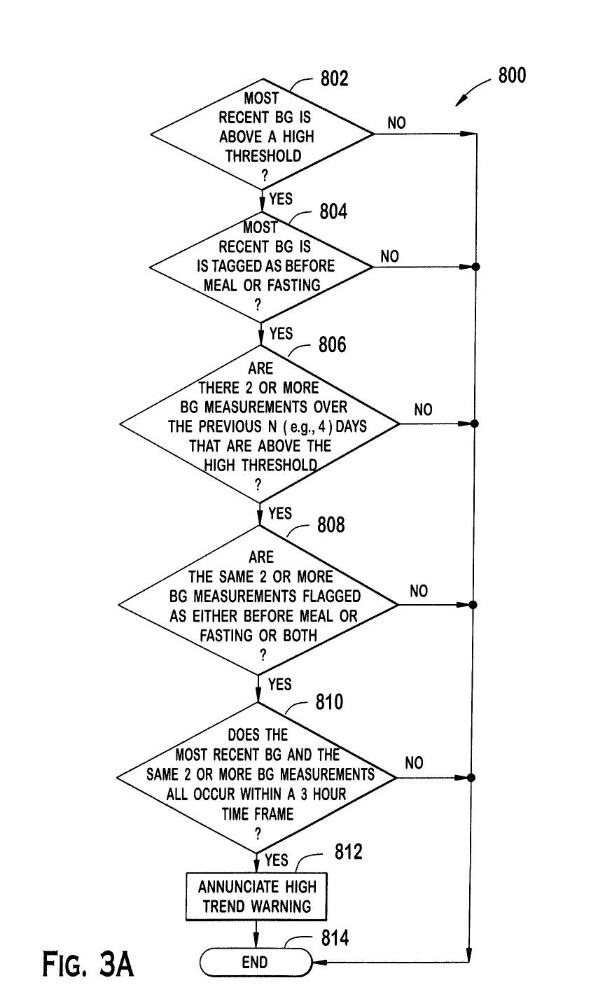

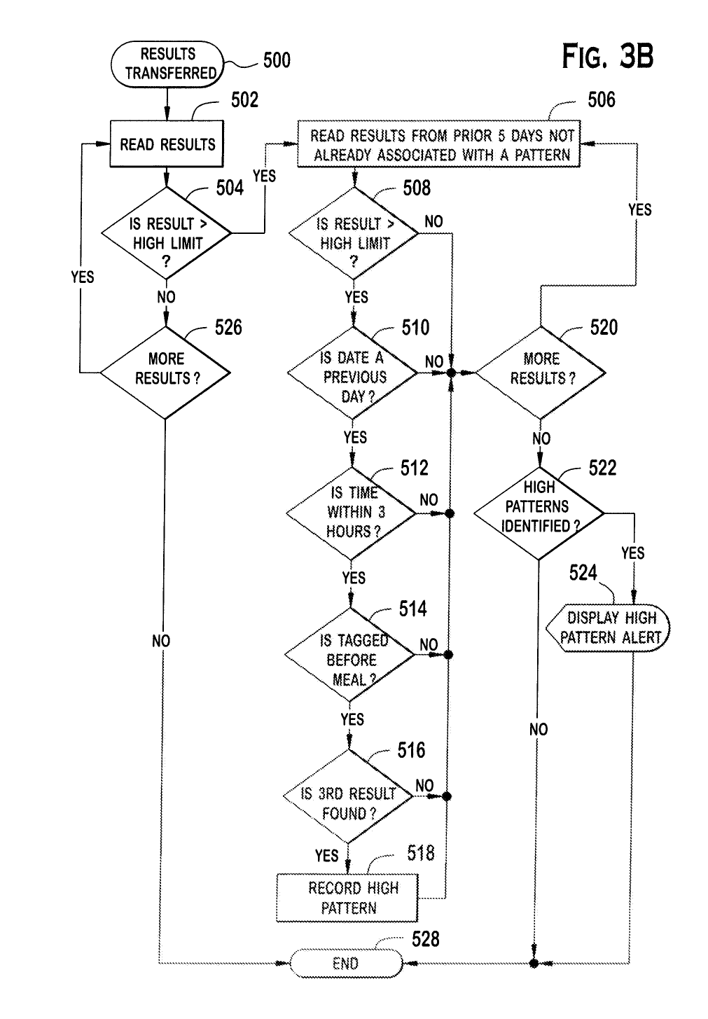

One functionality is provided in the system 100 to allow for the device 40 to alert the user to a high trend (or a low trend) of the analyte measurements taken recently. Two variations on the logic for the low trend pattern detection is shown and described herein relation to FIGS. 2A and 2B whereas two variations on a logic for high-trend pattern detection are described in FIGS. 3A and 3B.

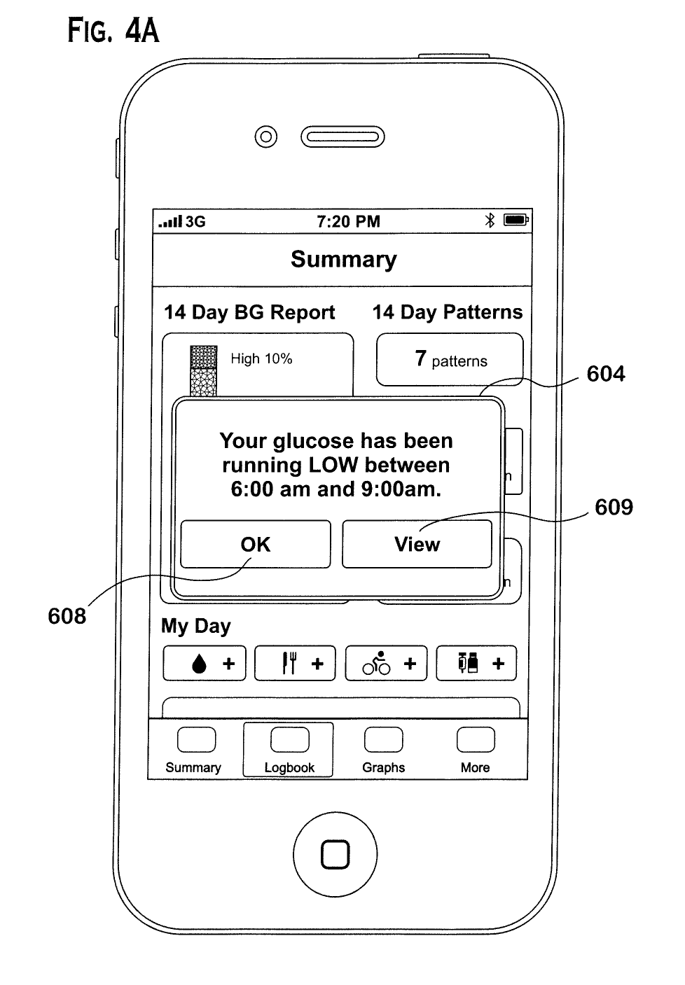

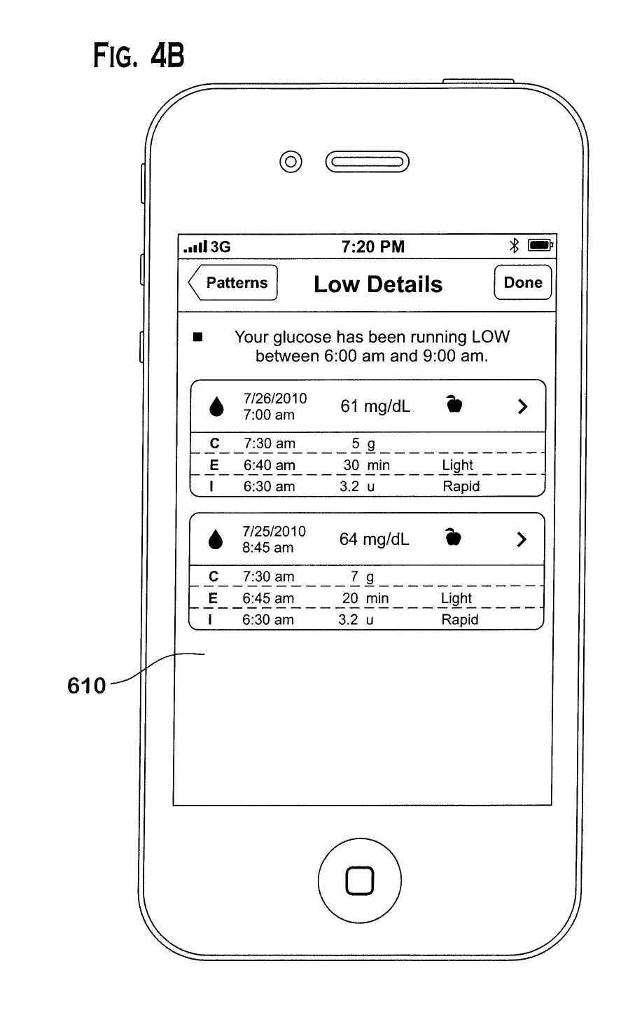

In FIG. 2A, the instant or most recent BG is compared at 402 to determine whether such BG result is below the first threshold. If true at 402 then the microprocessor determines at 404 whether at least one or more of the plurality of analyte measurements made within a window of X hours (e.g., approximately 3 hours from about 8 AM to about 11 AM) bracketing the same time period (9:30 AM) as the most recent BG measurement 602 were made in the most N number of days is lower than the first threshold. In one example, a BG result is 65 mg/dL which is below the preset first threshold of about 70 mg/dL. The BG was taken at about 9:30 AM. On the basis of the logic described herein, the microprocessor 52 will look to its stored analyte measurements that were taken at a time frame of X hours bracketing the time (i.e., about 930 AM) at which the most recent blood measurement was made in the previous N number of days to determine whether at least one analyte measurement in such bracketed time frame about the given time (i.e., 930 AM) is lower than the first threshold. If at least one prior measurement fits this condition, the microprocessor annunciates a message 406 to provide a technical effect in the form of a warning of a low trend (e.g., FIG. 4A). In particular, as shown in FIG. 4A, at screen 604, a text message may pop-up, in any screen, to indicate that a low trend has been detected for the same time frame bracketing the given time at which most recent analyte measurement of 65 mg/dL was made over each of a preset number N days. Where a user desires to view a last analyte result, screen 608 may be displayed and a selection for a low trend message 609 can be selected. Selection of the “view” button 609 allows the user to see details around the detection of the low trend such as, for example, a table listing the date, time, value of the BG results, and other contextual information relating to BG results such as, for example, exercise, food, or insulin drugs, as shown on screen 610 in FIG. 4B.

As an alternative to the logic of FIG. 2A, the logic of FIG. 2B can also be utilized. At 410, the logic flow begins with a transfer of one or more BG results from the AMU 10 to the hand-held computing unit 40. The processor 52 of the HCU 40 reads the BG results at 412 to begin the analysis for the low-pattern trend detection. At 414, a decision is made as to whether the result is lower than a pre-set low limit “LOW.” If true then the logic reads BG results collected from prior 5 days that are NOT utilized as part of any detected pattern. At 418, the logic checks to see if the most recent result is less than a LOW limit and if true, the logic flows to 420 where a decision is made to determine if at any time in the previous day, a prior date BG (“Prior BG”) result is lower than the LOW limit. If true, the process flows to step 422 where it is determined as to whether the Prior BG result falls within a time window (e.g., 3 hours) spanning the time at which the most recent BG results was taken. In this example, if the most recent BG result was taken at 9:00 A.M., the Prior BG must be: (a) lower than the LOW limit; and (b) taken at any time between 6:00 AM and 12 noon in the prior day or days. If true in 422, the program records these results as part of a low pattern 424. Returning back to decision 418, if the most recent result is equal to or greater than the LOW limit then the process flows to 426 at which the system checks to see if additional results were transferred while logic process from 414-424 was running. If true at 426, the process flow back to the excluder 416 and steps 418-424 are utilized once more. If false at 426, the process flows to decision 428 to determine if there are LOW patterns identified and stored in the HCU 40. If true, the HCU 40 annunciates a low pattern trend alert at 430.

Returning to process 414, if the process returns a false at 414, the flow proceeds to 432 to determine if there are updates to the results. Assuming that no new results were transferred while steps 412-424 were running, then the logic ends at 434.

A high trend detection logic 800 is also provided for the system, illustrated exemplarily here in FIG. 3A. To ensure proper operation of the high-trend pattern detection, a message may be provided in the device 40 to remind the user to tag or flag a BG measurement in order for high trends to be detected by the unit. Should the user persist in selecting the blank second threshold, a message is displayed to the effect that the tagging functionality must be enabled in order for high trends to be detected. This is intended to help users understand the relationship between the Before Meal limit and tagging. In other words, if tagging of before meal measurements are not made, then there is little value in providing high trend messages. Additionally, even if tagging is enabled, the user is reminded by message that tagging should be used consistently in order for the before meal high trend to be of value to the user.

In this logic flow of FIG. 3A, a logical query 802 is made as to whether a most recent BG result is above a high threshold. If true, a logical query 804 as to whether the most recent BG result has been tagged as a Before Meal BG result or a Fasting BG result. If true, the logic flows to query 806 to determine whether 2 or more Prior BG measurements over the previous N number of days (e.g., 4 days) that are above the high threshold. If true, the logic flows to query 808 to determine whether the same 2 or more BG results have both been flagged as either a Before Meal BG result or a Fasting BG result. If true, the logic flows to query 810 to determine whether the most recent BG result and the same 2 or more Prior BG results all occur within X hours time frame. If true, the logic 800 provides a technical effect of annunciating a high trend warning at output 812. In queries 802-810, if the logic returns a false then the routine ends at 814. In the preferred embodiments, the variable N can be of any value from about 2 to 90 days and X can be of any value from about 1 hour to about 12 hours.

As an example of the logic 800, it will be assumed that a user conducted a series of measurements from Monday to Friday with a most recent BG result at 9 AM on Friday, as set forth in Table 1 below:

TABLE 1

| | |
|---|---|
| Monday - 7:50 AM | Exceeds High Threshold |
| | Flagged as Fasting BG result |
| Tuesday - 10:49 AM | Exceeds High Threshold |
| | Flagged as Before Meal BG result |
| Wednesday - 7:40 AM | Exceeds High Threshold |
| | Flagged as Fasting BG result |
| Thursday - 11:30 AM | Exceeds High Threshold |
| | Flagged as Before Meal BG result |
| Friday - 9:00 AM | Exceeds High Threshold |
| (Most Recent BG result) | Flagged as Fasting BG result |

Referring to Table 1, the most recent BG has a logical true state for the logical queries 802 and 804 (i.e., exceeds the high threshold and flagged as fasting). At least one BG for each of the last four days has a logical true state for the logical queries 806 and 808. The logical query 810 must evaluate at least three BG's, which are the most recent BG (from queries 802 and 804) and the at least two BG's (from queries 806 and 808).

Based on the results collected in the previous 4 days, a warning message would be annunciated with the most recent BG on Friday at 9:00 AM. The 3 hour time bracket can include, in chronological order for time of day, 7:50 AM (Monday), 9:00 AM (Friday), and 10:49 AM (Tuesday), where the difference between the latest time and the earliest time is less than three hours (10:49 AM minus 7:50 AM=2 hours and 59 minutes). Thus, the Monday, Friday, and Tuesday BG's fall within the three hour time bracket. In addition to Monday, Friday, and Tuesday, the 3 hour time bracket can also include, in chronological order for time of day, 7:40 AM (Wednesday), 7:50 AM (Monday), and 9:00 AM (Friday), where the difference between the latest time and the earliest time is less than three hours (9:00 AM minus 7:40 AM=1 hour and 20 minutes).

Referring back to Table 1, there is no high trend alert for Wednesday. For Wednesday, 2 previous BG's and 1 most recent BG are evaluated in the logical query 810, which are 7:40 AM (Wednesday), 7:50 AM (Monday), and 10:49 AM (Tuesday), where the difference between the latest time and the earliest time is less than three hours (i.e., 10:49 AM minus 7:40 AM=3 hours and 9 minutes). Thus, the Wednesday, Monday, and Tuesday BG's do not fall within the three hour time bracket.

Referring back to Table 1, there is no high trend alert for Thursday. For Thursday, 2 previous BG's and 1 most recent BG are evaluated in the logical query 810. Note that there are three combinations of previous days that can be evaluated in the logical query 810, which are Monday/Tuesday; Monday/Wednesday; and Tuesday/Wednesday. Here, combining any one of the combinations of previous days with the most recent BG does not result in three BG's falling within the three hour time bracket.

Note that in the embodiment set forth in Table 1, only one glucose concentration per day was depicted that exceeds the high threshold and flagged as fasting. In other situations, there may be more than one glucose concentration per day that exceed the high threshold and are flagged as fasting. In such a case, the number of combinations of 3 BG's that need to be evaluated by the logic 800 will increase.

As a further demonstration of the applicability of logic routine 800, consider that the user further conducted a most recent BG measurement on the Saturday following the Friday (of Table 1), set forth herein Table 2.

TABLE 2

| | |
|---|---|
| Monday - 750 AM | Exceeds High Threshold |
| | Flagged as Fasting BG result |
| Tuesday - 10:49 AM | Exceeds High Threshold |
| | Flagged as Before Meal BG result |
| Wednesday - 7:40 AM | Exceeds High Threshold |
| | Flagged as Fasting BG result |
| Thursday - 11:30 AM | Exceeds High Threshold |
| | Flagged as Before Meal BG result |
| Friday - 9:00 AM | Exceeds High Threshold |
| | Flagged as Fasting BG result |
| Saturday - 11:50 AM | Exceeds High Threshold |
| (Most Recent BG) | Flagged as Before Meal BG result |

In Table 2, the logic 800 would detect a high trend alert on Saturday (at 11:50 AM), which would be annunciated with the most recent BG. Note that there are six combinations of previous days that can be evaluated in the logical query 810, which are Monday/Tuesday; Monday/Wednesday; Monday/Thursday; Tuesday/Wednesday; Tuesday/Thursday; and Wednesday/Thursday. The 3 hour time bracket can include, in chronological order for time of day, 10:49 AM (Tuesday), 11:30 AM (Thursday), and 11:50 AM (Saturday), where the difference between the latest time and the earliest time is less than three hours (i.e., 11:50 AM minus 10:49 AM=1 hour and 1 minute). Thus, the Tuesday, Thursday, and Saturday BG's fall within the three hour time bracket. In summary based on Table 2, the user would be provided two messages: one on Friday and another message on Saturday. Alternatively, however, only one message may be generated on Saturday that reports the two high trends by prioritization of the trend data. Prioritization of the high trend or low trend reports can be based on the following: once a glucose value is used for a (high or low) trend, it will no longer be included in other (high/low) trends; if multiple trends are detected, the tightest clustering of results will be the one reported; or if there are multiple high and low BG measurements with an hour, only the first will be included in trend analysis (i.e., if there are either multiple high values with an hour or multiple low values within an hour, only the first will be included in trend analysis). Alternatively, the prioritization can be based on based on chronological closeness or based on the tightness of the clustering which can be determined by the closest 2 BG results in time to the most recent BG result, or the closest 3 BG results in time to the most recent BG result.

An alternate logic may also be utilized to detect high BG trend(s), illustrated exemplarily here in FIG. 3B. In FIG. 3B, the logic flow begins at 500 with a transfer of one or more BG results from the AMU 10 to the hand-held computing unit 40. The processor 52 of the HCU 40 reads the BG results at 502 to begin the analysis for the high-pattern trend detection. At 504, a decision is made as to whether the result is higher than a pre-set high limit “HIGH.” If true then the logic reads at 506 BG results collected from prior 5 days that are NOT utilized as part of any detected pattern. At 508, the logic checks to see if the most recent result is greater than a HIGH limit and if true it is determined at 510 as to whether the Prior BG result falls was in a prior day at 510, within a time window (e.g., 3 hours) spanning the time at which the most recent BG results was taken at 512, tagged or flagged as a “Before Meal” measurement at 514, and at least 3 such results found at 516 then in such case, a high pattern is recorded for these results. In this example, if the most recent BG result was taken at 9:00 A.M., the Prior BG must be: (a) higher than the HIGH limit; (b) taken at any time between 6:00 AM and 12 noon in the prior day or days; (c) flagged as Before Meal; (d) with at least 3 such prior measurements fitting these thresholds. Returning back to decision step 508, if the most recent result is not greater than the HIGH limit then the process flows to 520 at which the system checks to see if additional results were transferred while logic process from 504-518 was running. If true at 520, the process flow back to the exclusionary step 506 and steps 508-518 are utilized once more. If is determined to be false at 520, the process flows to decision 428 to determine if there are HIGH patterns identified and stored in the HCU 40. If true, the HCU 40 annunciates a high pattern trend alert at 524.

Returning to process 500, if the process returns a false at 504, the flow proceeds to 526 to determine if there are updates to the results. Assuming that no new results were transferred while steps 508-518 were running, then the logic ends at 528. In the preferred embodiments, the window of X hours includes any numerical value from about 1 to about 6 hours (or hours expressed in minutes) and the N number of days may range from about 2 to about 21 days. In another preferred embodiment, the window of X hours include about 3 hours and the N number of days may range from about 2 to about 30 days, and most preferably from about 2 to about 5 days. In a further preferred embodiment, the N number of days may range from about 2 days to about 90 days. It is noted that the word “days” denote any 24 hour period which may have its start time coinciding with the commonly understood starting point (e.g., 4 AM-8 AM) of a user.

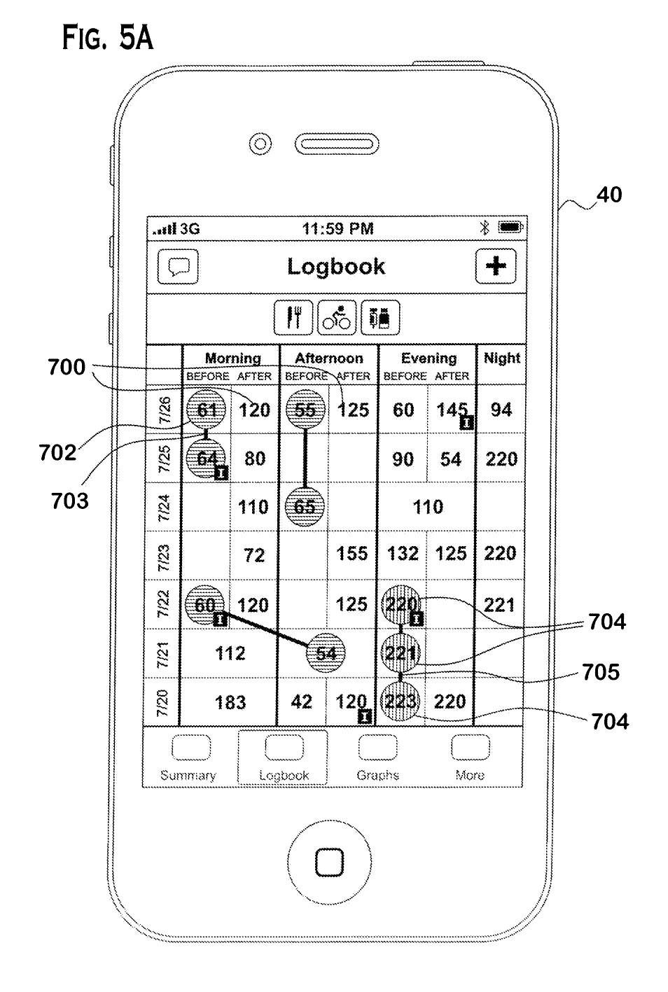

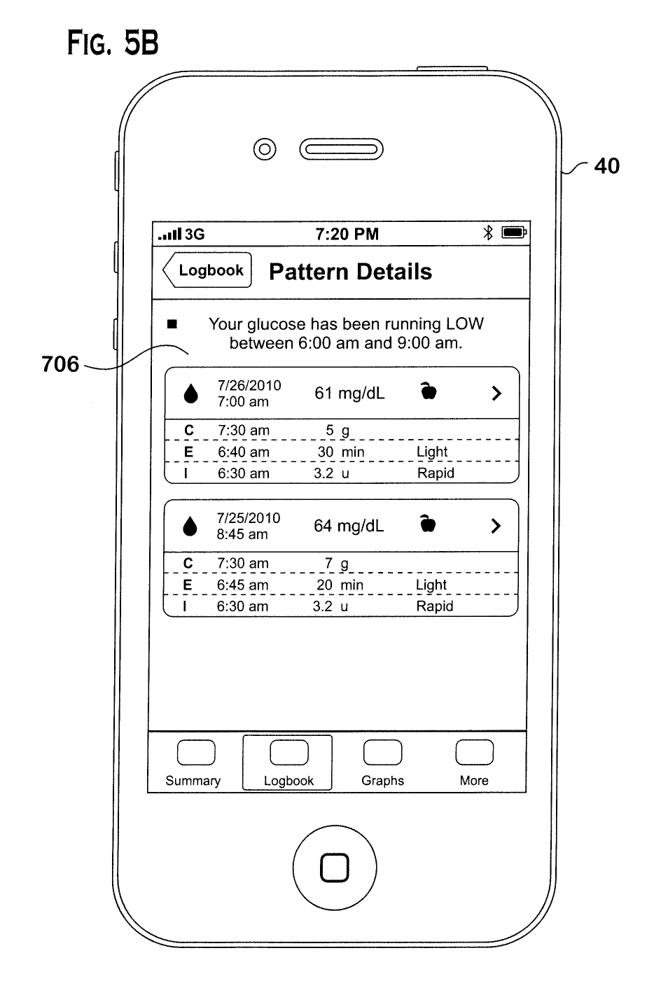

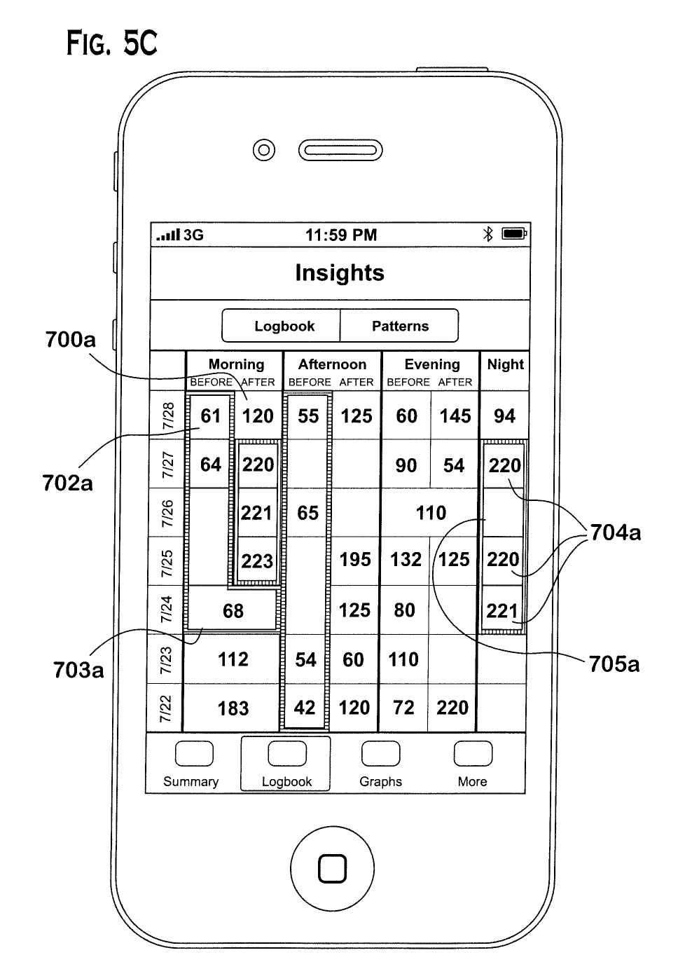

The high patterns or low patterns are stored in the HCU 40 and annunciated to the user in a unique manner. Specifically, as shown in FIG. 5A, the display of the HCU 40 can be controlled by its processor to evaluate whether the measurements stored in the HCU are part of one or more patterns. If the results are not part of any high or low patterns, the results, (shown here, for example, the result 700 denoting the value “120” in the “Morning” column on “July 26” as an “After Meal” measurement) are displayed such that its brightness is dimmed substantially in relation to other indicia on the screen. Where the results are part of a low-trend (e.g., reference 702 denoting a low trend in a “Morning” time period for both July 25 and 26^{th}) the results are displayed as a first indicia such as for example, a polygon in a first color such as, for example, a solid circle with a connector 703 between each of the solid circles. A numerical value of the measurement may also be provided as an overlay on the polygon. Where the results are part of a high-trend (e.g., reference 704 denoting a high trend the “Evening” time periods for July 20, 21, and 22), the results are displayed as a second indicia such as, for example, a polygon in a second color different from the first color. A connector 705 may be utilized to indicate that these values are part of a high trend in accordance with the logic described herein. Other indicia (e.g., symbol, color, markings) can also be utilized to provide other contextual data relating to the analyte measurement. In this example, the display of HCU 40 can be configured to display the upper case letter “I” to indicate that insulin was taken around the time that the measurement of 64 was obtained.

Referring to FIG. 5C, an alternate display for high or low patterns of FIG. 5A can be provided. For example, the results, (shown here, for example, the result 700a denoting the value “120” in the “Morning” column on “July 26” as an “After Meal” measurement) are displayed such that its brightness is dimmed substantially in relation to other indicia on the screen. Where the results are part of a low-trend (e.g., reference 702a denoting a low trend in a “Morning” time period for July 24^{th}, 25^{th} and 26^{th}) the results are displayed as a first indicia such as for example, a polygon in a first color such as, for example, the series of connected and merged squares 703a connecting the values on July 24^{th}, 25^{th}, and 26^{th}. A numerical value of the measurement may also be provided inside the polygon. Where the results are part of a high-trend (e.g., reference 704a denoting a high trend the “Night” time periods for July 24^{th}, 25^{th} and 27^{th}), the results are displayed as a second indicia such as, for example, a polygon in a second color different from the first color. A series of squares merged with each other form polygon 705a may be utilized to indicate that these values are part of a high trend in accordance with the logic described herein.

Where the user desires more details to the trends, the user may touch the relevant indicia in FIG. 5A or 5C, such as for example, the low trend pattern on July 25 and 26. This would cause the HCU 40 to display the data in more detail in FIG. 5B such as, for example, that the measurement of 61 mg/dL was taken at 7:00 AM before a meal (represented by an indicia) and other contextual data such as, for example, carbohydrates “C” at 730 AM in the amount of 5 grams, with light exercise “E” at 640 AM and rapid-acting insulin “I” at 630 AM.

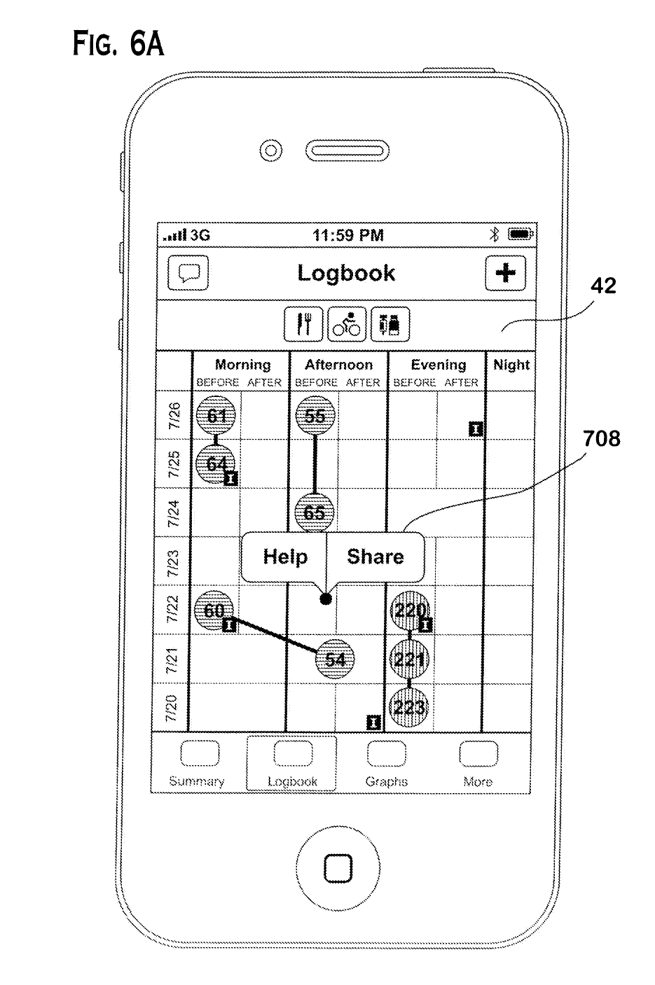

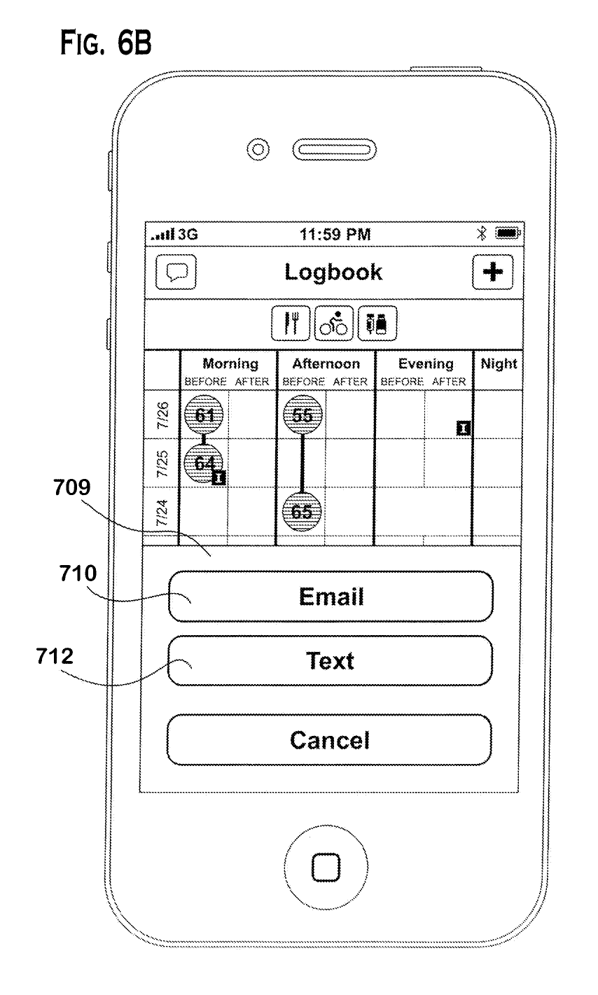

The exemplary system also allows the log-book to be shared with caretaker or a health care provider or for the user to seek help in interpreting the log-book. This feature is shown in FIGS. 6A and 6B. In FIG. 6A, should the user desires to share the output of the log-book, the user simply taps on a suitable open area of the touch screen 40. This initiates a pop-up selection 708 for the user to select between “Help” and “Share.”

Selection of “Help” activates a suitable media such as, for example, a video on the effects of glucose values trending lower over time or approved articles from health care providers. Alternatively, selection of “Help” opens a call to a pre-selected phone number or to a website. Selection of “Share” activates an overlay 709 with 3 choices: sending an email with a copy of the log-book to another user; sending a text message that includes textual description of the log-book; or canceling this feature.

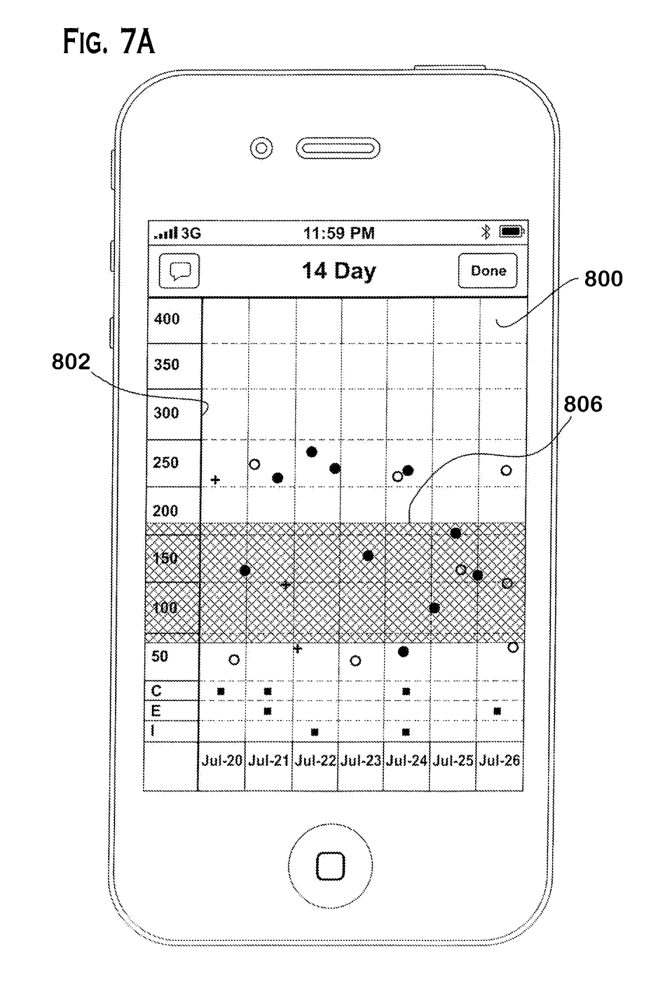

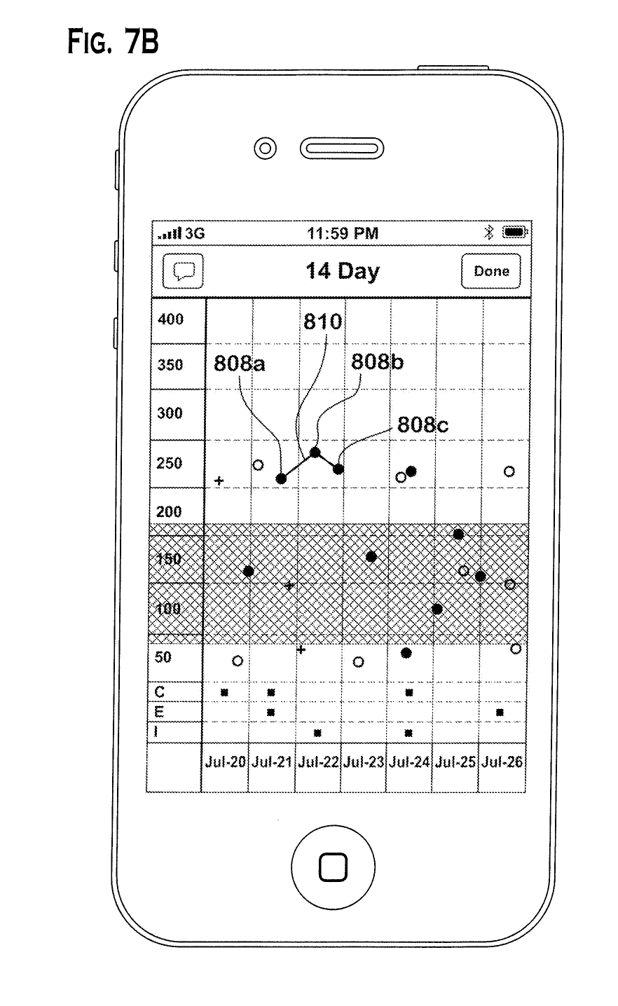

Another feature that the system also provides is the ability to display analyte measurements in a graphical format. In this example, in screen 800 of FIG. 7A, the measurements are plotted in a Cartesian graph with numerical values referenced at 802 for the analyte values from 50 to 400 (in mg/dL) and different indicia to indicate high trend, low trend, carbohydrates, exercise, or insulin over a range of dates as referenced at 804. In screen 800, the graph is overlaid with a semi-transparent rectangle 806 denoting an acceptable range for the analyte measurements from, for example, 60 to 170 (in mg/dL). A solid polygon in a first color may indicate that the measurement belongs to a low-trend pattern; a solid polygon in a second color may indicate that the measurement belongs to a high-trend pattern. In FIG. 7B, three measurements denoted by 808a, 808b, and 808c are shown as part of a high-trend determined using one or more of the high-trend pattern determination logic of FIGS. 3A and 3B.

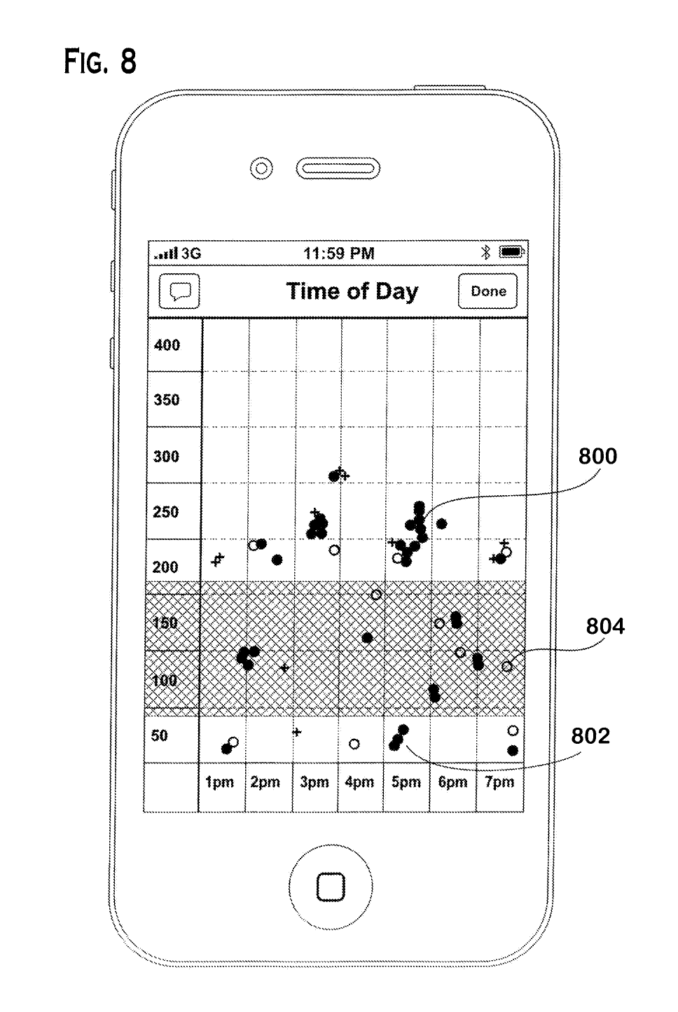

Instead of displaying the measurements plotted against a numerical range and date as in FIGS. 7A and 7B, the HCU 40 may also plot the measured analyte values against a numerical range and time of day irrespective of the number of days. As shown in FIG. 8, measurements 800 that are part of a high-trend measured around 5 pm for a number of days are displayed as a cluster of measurements using a first indicia, which may include a solid polygon and a first color. Measurements 802 that are part of a low-trend over a number of days at around 5 PM are also displayed as a cluster using a second indicia, which may include a solid polygon and a second color different from the first color. Measurements that are not flagged but taken around certain times of the day can be represented by a third indicia, which may include a circle with a third color. One example is shown here with reference number 804.

By virtue of the system and processes described herein, a method of notifying a user of high or low trends in analyte values obtained with an analyte measurement unit is provided. The method may include the steps of: performing with the microprocessor, a plurality of analyte measurements; storing in the memory, the plurality of analyte measurements; determining whether a most recent analyte measurement is below a first threshold or above a second threshold; evaluating with the microprocessor, whether at least one analyte measurement of the plurality of analyte measurements performed within a time frame as the most recent analyte measurement over a period of N days, is lower than the first low threshold or higher than the second threshold; and annunciating that in the same time frame of at least two days over the N number of days, the plurality of analyte measurements indicates a trend lower than the low threshold or a trend higher than a second threshold.

Furthermore, the various methods described herein can be used to generate software codes using off-the-shelf software development tools such as, for example, Visual Studio 6.0, C or C++ (and its variants), and suitable software-development-kit (“SDK”) from Apple, Blackberry, Google, and other less well-known software and hardware providers. The methods, however, may be transformed into other software languages depending on the requirements and the availability of new software languages for coding the methods. Additionally, the various methods described, once transformed into suitable software codes, may be embodied in any computer-readable storage medium that, when executed by a suitable microprocessor or computer, are operable to carry out the steps described in these methods along with any other necessary steps.

While the invention has been described in terms of particular variations and illustrative figures, those of skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A method of notifying a user of high or low trends in analyte values obtained with an analyte measurement unit and used in conjunction with a mobile communication device, each having a microprocessor coupled to respective displays and memory storage devices, the method comprising:
transforming with the analyte measurement unit, an analyte in a physiological fluid into an enzymatic by-product and in the process provide a measurement of the analyte in the fluid;
storing in the memory of the analyte measurement unit, one or more of the analyte measurements;
determining with the mobile communication device, whether a most recent analyte measurement at a given time during a day is below a first threshold;
evaluating with the mobile communication device, whether at least one analyte measurement of the plurality of analyte measurements performed within a time frame of X hours about the given time of the most recent analyte measurement over a period of N days, is lower than a first threshold; and
annunciating in the mobile communication unit that, in the same time frame over the N number of days, the plurality of analyte measurements indicates an analyte trend lower than the first threshold with a first indicia.

2. A method of notifying a user of high or low trends in analyte values obtained with an analyte measurement unit and used in conjunction with a mobile communication device, each having a microprocessor coupled to respective displays and memory storage devices, the method comprising:
Initiating with the analyte measurement unit, a transformation of an analyte in a physiological fluid into an enzymatic by-product and in the process provide a measurement of the analyte in the fluid;
storing in the memory of the analyte measurement unit, one or more of the analyte measurements;
determining whether a most recent analyte measurement at a given time during a day is above a second threshold;
confirming whether the most recent analyte measure was flagged as either or both of (a) a measurement made before a meal or (b) a measurement made during a fasting period;
evaluating with the mobile communication device, whether at least one analyte measurement of the plurality of analyte measurements performed within a time frame of X hours about the given time of the most recent analyte measurement over a period of N days, is higher than the second threshold; and
annunciating that in the same time frame over the N number of days, the plurality of analyte measurements indicates another analyte trend higher than a second threshold with a second indicia.

3. The method of claim 1 or claim 2, in which the annunciating comprises:
displaying a plurality of analyte measurements on the display of the mobile communication device in a table having multiple rows and multiple columns with respective row header and column header, the column header signifying different time periods during a day with subdivisions of each of the column header to signify a before meal or after meal analyte measurement within each time period of the day, and the row header signifying the date of each analyte measurement, and in which numerical values representing analyte values identified as part of one analyte trend are represented by a first indicia and as part of another analyte trend by a second indicia different from the first indicia.

4. The method of claim 3, in which the analyte comprises glucose.

5. The method of claim 4, in which the displaying comprises showing a distribution of the first indicia of stored analyte for a trend of analyte measurements lower than the first threshold within a time frame of X hours about the given time of the most recent analyte measurement over a period of N days being connected to each other.

6. The method of claim 4, in which the displaying comprises showing a distribution of the second indicia of stored analyte for a trend of analyte measurements higher than the second threshold within a time frame of X hours about the given time of the most recent analyte measurement over a period of N days being connected to each other.

7. The method of claim 4, in which the N number of days comprises any number from about 2 to about 14.

8. The method of claim 4, in which the X hours comprises any number between about 0 and about 7 hours.

9. The method of claim 4, in which the X hours comprises any number from about 0 to about 3 hours.

10. The method of claim 4, in which the first threshold comprises about 70 mg of glucose per deciliter of blood.

11. The method of claim 4, in which the second threshold comprises about 150 mg of glucose per deciliter of blood.

12. A chronic disease management system comprising:
at least one analyte test strip; and
an analyte measurement unit comprising:
a housing including a test strip port configured to receive the analyte test strip;
an analyte microprocessor coupled to the test strip port to provide data regarding an amount of analyte measured in a user's physiological fluid deposited on the test strip, the microprocessor further coupled to a memory;
a mobile communication unit comprising a mobile processor coupled to a display, one of the analyte microprocessor or the mobile microprocessor being programmed to:
(a) measure an analyte in a physiological fluid to provide an analyte measurement;
(b) store one or more of the analyte measurements;
(c) determine whether a most recent analyte measurement at a given time during a day is below a first threshold;
(d) evaluate whether at least one analyte measurement of the plurality of analyte measurements performed within a time frame of X hours about the given time of the most recent analyte measurement over a period of N days, is lower than a first threshold
(e) annunciate, upon completion of the evaluation, that in the same time frame of at least two days over the N number of days, the plurality of analyte measurements indicates an analyte trend lower than the low threshold or a trend higher than a second threshold; and
(f) display the plurality of analyte measurements on the display of the mobile communication device in a table having multiple rows and multiple columns with respective row header and column header, the column header signifying different time periods during a day with subdivisions of each of the column header to signify a before meal or after meal analyte measurement within each time period of the day, and the row header signifying the date of each analyte measurement, and in which numerical values representing analyte values identified as part of one analyte trend are represented by a first indicia and as part of another analyte trend by a second indicia different from the first indicia.

13. The system of claim 12, in which the microprocessor is further programmed to confirm whether the most recent analyte measure was flagged as one of predetermined conditions including (a) a measurement made before a meal or (b) during a fasting period.

14. The system of claim 13, in which the microprocessor is further programmed to confirm whether the most recent analyte measure is below a first threshold as the predetermined condition.

15. The system of claim 14, in which the N number of days comprises any number from about 2 to about 14 and the X hours comprises any number between about 0 and about 7 hours.

16. The system of claim 14, in which the X hours comprises any number from about 0 to about 3 hours.

17. The system of claim 14, in which the first threshold comprises about 70 mg of glucose per deciliter of blood and the second threshold comprises about 150 mg of glucose per deciliter of blood.

18. A chronic disease management system comprising:
an analyte measurement unit comprising:
a housing including a test strip port configured to receive an analyte test strip;
a test strip port to provide data regarding an amount of an analyte from a user's physiological fluid deposited on one or more test strip;
an analyte microprocessor coupled to a memory, the memory configured to store data representing a plurality of analyte measurements; and
a mobile communication unit comprising:
a mobile processor coupled to a display, in which one of the analyte microprocessor or the mobile microprocessor is configured to determine whether at least one analyte measurement of the plurality of analyte measurements performed within a time frame of X hours about the given time of a most recent analyte measurement over a period of N days, is lower than a first threshold, and display in a time frame over the N number of days, an analyte trend lower than the first threshold.

19. A chronic disease management system comprising:
an analyte measurement unit comprising:
a housing including a test strip port configured to receive an analyte test strip;
a test strip port to provide data regarding an amount of an analyte from a user's physiological fluid deposited on one or more test strip;
an analyte microprocessor coupled to a memory, the memory configured to store data representing a plurality of analyte measurements;
and
a mobile communication unit comprising:
a mobile processor coupled to a display, in which one of the analyte microprocessor or the mobile microprocessor is configured to determine whether at least one analyte measurement of the plurality of analyte measurements performed within a time frame of X hours about the given time of a most recent analyte measurement over a period of N days, is higher than the second threshold, and display in a time frame over the N number of days, an analyte trend higher than the second threshold.

20. The system of claim 18, in which the first threshold comprises about 70 mg of glucose per deciliter of blood.

21. The system of claim 19, in which the second threshold comprises about 150 mg of glucose per deciliter of blood.

22. The system of one of claim 18 or claim 19, in which the N number of days comprises any number from about 2 to about 14 and the X hours comprises any number between about 0 and about 7 hours.

23. The system of claim 22, in which the X hours comprises any number from about 0 to about 3 hours.

24. The system of claim 18, in which the plurality of analyte measurements comprises at least two glucose measurements.

25. The system of claim 19, in which the plurality of analyte measurements comprises at least three glucose measurements
